(19) United States
(12) Patent Application Publication
(10) Pub. No.: US 2025/0245495 A1
(43) Pub. Date: Jul. 31, 2025

(54) DATA PROCESSING METHODS

(71) Applicant: MEDIATEK INC., Hsinchu City (TW)

(72) Inventors: Chun-Chen Lin, Hsinchu City (TW); Chia-Da Lee, Hsinchu City (TW); Chia-Lin Yu, Hsinchu City (TW); Jia-Ren Chang, Hsinchu City (TW); Chih-Wen Goo, Hsinchu City (TW); Chih-Wei Chen, Hsinchu City (TW)

(21) Appl. No.: 19/023,602

(22) Filed: Jan. 16, 2025

Related U.S. Application Data
(60) Provisional application No. 63/624,820, filed on Jan. 25, 2024.

(51) Int. Cl. G06N 3/0495

(52) U.S. Cl. CPC G06N 3/0495

(57) ABSTRACT

A data processing method for quantization, includes the following steps. A first set of models are loaded. The first set of models are quantized based on a unified quantization parameter to obtain a first set of quantized models. The first set of models include at least one model, the first set of quantized models include at least one quantized model, and the unified quantization parameter is obtained according to several quantization parameters of a second set of models.

This application claims the benefit of U.S. provisional application Ser. No. 63/624,820, filed Jan. 25, 2024, the disclosure of which is incorporated by reference herein in its entirety.

### TECHNICAL FIELD

The disclosure relates to a data processing mechanism, and more particularly it relates to a data processing method for quantization in artificial intelligent (AI) generation tasks.

### BACKGROUND

Artificial intelligent (AI) technology can be widely utilized for various applications, including generation tasks to generate images from text. In the generation tasks for images, various model adaptations may be utilized to obtain different kinds of styles and characters of the images, such that customization/personalization can be achieved to meet user's requirement.

Various model adaptations may involve several different adapted models. These models have a neural network structure with multiple weights and biases (i.e., for operation) and multiple activations (i.e., for I/O). These weights, biases and activations usually have floating-point values. For a purpose of inference efficiency, before being compiled and inferenced, the models must be quantized to have fixed-point values or integer values.

Furthermore, before being quantized, the models must be calibrated to evaluate value ranges thereof. However, the calibration process is time-consuming, which includes collecting calibration data, analyzing each node and layer in the models with the calibration data, etc. When a large number of adapted models are employed, each model has to undergo the calibration process, which will cause a great calibration time and hence deteriorate model efficiency.

In view of the above issues, it is desirable to have an improved data processing mechanism which can enhance model efficiency.

### SUMMARY

According to one embodiment of the present disclosure, a data processing method for quantization is provided. The data processing method includes the following steps. A first set of models are loaded. The first set of models are quantized based on a unified quantization parameter to obtain a first set of quantized models. The first set of models include at least one model, the first set of quantized models include at least one quantized model, and the unified quantization parameter is obtained according to several quantization parameters of a second set of models.

According to another embodiment of the present disclosure, a data processing method for quantization is provided. The data processing method includes the following steps. A network is loaded, the network includes several operation units. The network is quantized based on a unified quantization parameter to obtain a quantized network. The unified quantization parameter is obtained according to several quantization parameters of a set of modified networks, wherein the set of modified networks are obtained by inputting several groups of weights into the network.

### BRIEF DESCRIPTION OF THE DRAWINGS

FIG. 1 is a flow diagram of a data processing method according to an embodiment of the present disclosure.

FIG. 2 is schematic diagrams showing the data processing method of FIG. 1.

FIG. 3 is a flow diagram of a pre-calibration process for obtaining a unified quantization parameter according to an embodiment of the present disclosure.

FIG. 4 is a schematic diagram showing the pre-calibration process for obtaining the unified quantization parameter.

FIG. 5 is a schematic diagram illustrating quantization parameters for models.

FIG. 6 is a flow diagram of a data processing method according to another embodiment of the present disclosure.

FIG. 7A is a schematic diagram showing an exemplary structure of the network.

FIG. 7B is a schematic diagram showing weighted model adaptations.

FIG. 8 is a schematic diagram showing the data processing method of FIG. 6.

FIG. 9 is a flow diagram of a pre-calibration process for obtaining a unified quantization parameter in the embodiment of FIG. 6.

FIG. 10A is a schematic diagram showing the pre-calibration process of FIG. 9.

FIG. 10B is a schematic diagram showing modified networks formed based on weight groups.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The data processing method of the present disclosure is used to process computational models in artificial intelligent (AI) applications. More particularly, the data processing method provides a quantization mechanism for efficiently quantizing the computational models.

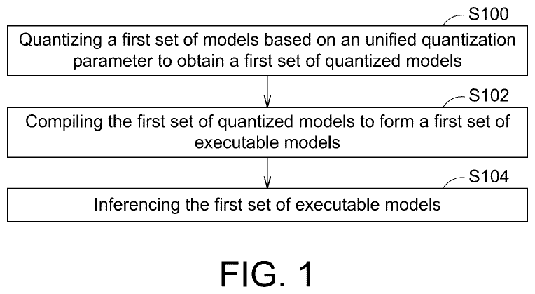

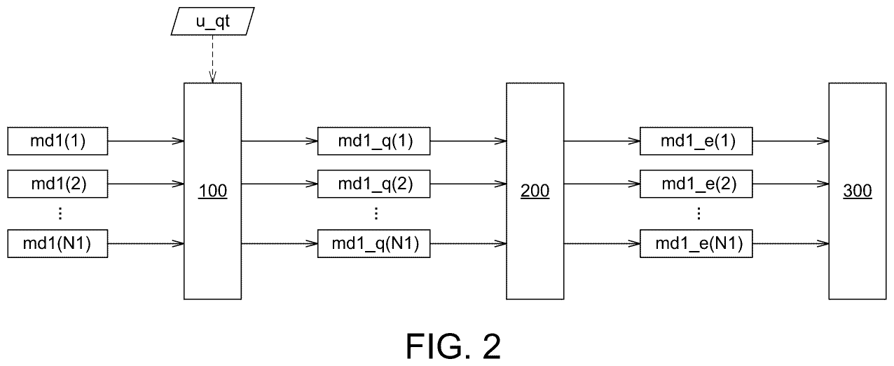

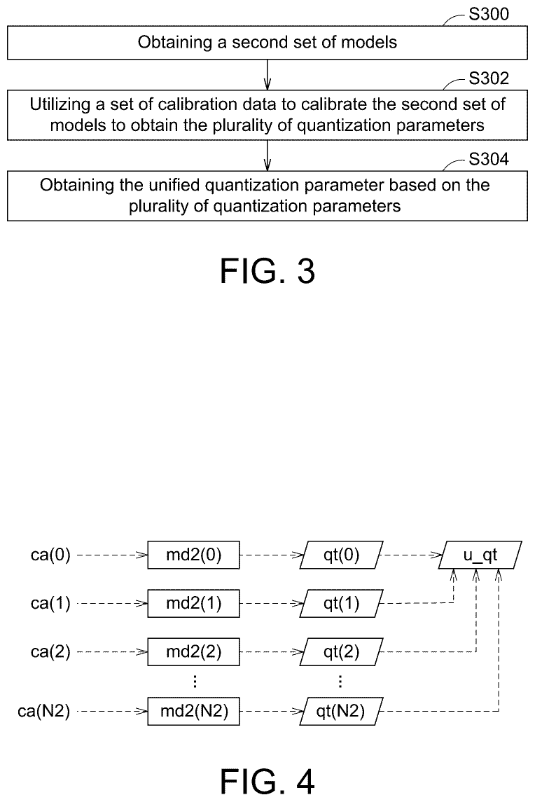

FIG. 1 is a flow diagram of a data processing method according to an embodiment of the present disclosure. FIG. 2 is schematic diagrams showing the data processing method of FIG. 1. Referring to both FIGS. 1 and 2, the data processing method begins at step S100: executing a quantization process. In the quantization process, quantizing a first set of models based on a unified quantization parameter to obtain a first set of quantized models, wherein the first set of models comprise at least one model. For example, in step S100, a plurality of models md1(1)˜md1(N1) are processed. More particularly, each of the models md1(1)˜md1(N1) is quantized based on a unified quantization parameter u_qt, so as to form a plurality of quantized models md1_q(1)˜md1_q(N1). The unified quantization parameter u_qt is predetermined. In some embodiments, the unified quantization parameter u_qt is obtained according to a pre-calibration process of a set of models md2(0)˜md2(N2) (which may be referred to as “a second set of models”), and such a pre-calibration process will be discussed later by reference to FIGS. 3-5. Now still referring to FIGS. 1 and 2, in the quantization process, the quantization for the models md1(1)˜md1(N1) may be executed by a quantization unit 100, where the quantization unit 100 may be a hardware circuit or a software module. These models md1(1)˜md1(N1) having floating-point values (e.g., floating-point values with 32 points (FP32)), and are respectively quantized to form the quantized models md1_q(1)˜md1_q(N1). The quantized models md1_q(1)˜md1_q(N1) may have fixed-point values or integer values (e.g., integer values with 16 points (INT16)). Although not shown, before step S100, the data processing method of this disclosure may further comprises loading the at least one model into a quantization module, such as the quantization unit 100.

Next, the data processing method proceeds to step S102: executing compilation process. In the compilation process, compiling the first set of quantized models to form a first set of executable models, wherein the first set of executable models comprises at least one executable model. For example, in step S102, the quantized models md1_q(1)˜md1_q(N1) are compiled and converted to form a plurality of executable models md1_e(1)˜md1_e(N1). The compilation may be executed by a compilation unit 200 which may be a hardware circuit or a software module.

Next, the data processing method proceeds to step S104: executing an inference process. In the inference process, inferencing the first set of executable models. For example, in step S104 the executable models md1_e(1)˜md1_e(N1) are inferenced/deployed on an execution module 300 (e.g., an execution module of a smart phone, a panel computer, and a laptop computer, etc.) in an application field. On the execution module 300, the executable models md1_e(1)˜md1_e(N1) may be inferenced, so as to process interested image(s) with various styles and/or characters.

In this disclosure, the models md1(1)˜md1(N1) are directly quantized (i.e., without calibration) based on the predetermined unified quantization parameter u_qt and not calibrated, hence, calibration time may be saved and model efficiency may thus be enhanced.

Now, referring to FIGS. 3, 4 and 5 to discuss the afore-mentioned pre-calibration process on the second set of models (i.e., models md2(1)˜md2(N2). More particularly, FIG. 3 is a flow diagram of the pre-calibration process for obtaining the unified quantization parameter u_qt according to an embodiment of the present disclosure, and FIG. 4 is a schematic diagram showing the pre-calibration process for obtaining the unified quantization parameter u_qt. As shown in FIGS. 3 and 4, firstly, the pre-calibration process begins at step S300: executing a model preparation process. In the model preparation process, obtaining a plurality of models, such as the second set of models mentioned before. For example, a plurality of models md2(0)˜md2(N2) (i.e., the second set of models as afore-mentioned) are prepared/obtained. These models md2(0)˜md2(N2) have a total number of (N2+1) models. Each of the models md1(0)˜md1(N1) and the models md2(0)˜md2(N2) is a computational model for AI generation tasks. In one example, each of the models md1(0)˜md1(N1) and the models md2(0)˜md2(N2) is a stable diffusion model for performing text-to-image generation for interested image(s). Among these models md2(0)˜md2(N2), the model md2(0) is a “base model” (e.g., a SD1.5 model). On the other hand, each of other models md2(1)˜md2(N2) is an “adapted model” adapted from the base model md2(0), for customization and personalization. For example, each of the models md2(1)˜md2(N2) may be performed with a model adaptation (MA) based on the model md2(0).

The model adaptation may be performed by adapters. The adapters may provide task-specific or domain-specific customization. Such as, the adapters may be small neural network (NN) modules which can be inserted into the base model md2(0), such that the base model md2(0) can be adapted to fit predefined tasks or predefined domains. In one example, the adapters may perform model adaptations, such as low-rank adaptation (LoRA) or other adaptation methods. The LoRA is associated with various styles and/or characters of the interested image(s). More particularly, taking three models md2(1)˜md2(3) as an example: the model md2(1) is adapted with LoRA based on the model md2(0) to form a “Cyberpunk style” of the interested image. Furthermore, the model md2(2) is adapted with LoRA based on the model md2(0) to form a “MoXin style” of the interested image. Moreover, the model md2(3) is adapted with LoRA based on the model md2(0) to form a “Crayons style” of the interested image. When the interested image is a person-portrait, the models md2(1), md2(2), and md2(3) may be adapted to fit a character of a specific person.

In another example, each of the models md1(0)˜md1(N1) and the models md2(0)˜md2(N2) is a large language model (LLM) for performing natural language processing tasks (e.g., language generation). The large language models may learn statistical relationships of texts during self-supervised and semi-supervised training. Likewise, the large language models may be personalized or customized through adapters for model adaptations.

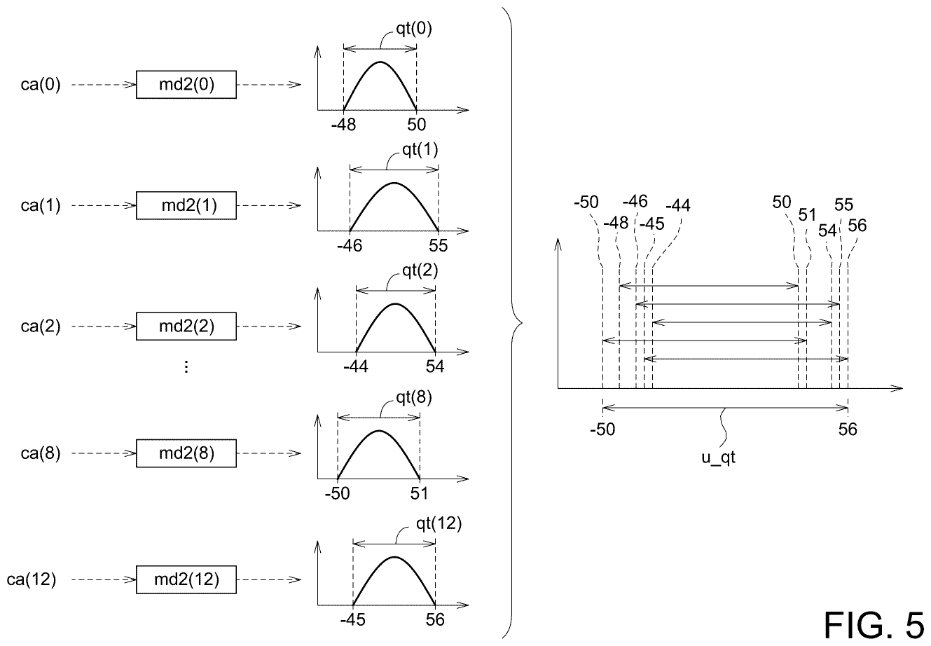

Next, the pre-calibration process proceeds to step S302: executing a calibration process. In the calibration process, utilizing a set of calibration data to calibrate the second set of models to obtain the plurality of quantization parameters. For example, a set of calibration data ca(0)˜ca(N2) are provided for calibrating the models md2(0)˜md2(N2), so as to obtain respective quantization parameters qt(0)˜qt(N2) of the models md2(0)˜md2(N2) correspondingly. More particularly, the calibration data ca(0)˜ca(N2) are fed into the models md2(0)˜md2(N2) correspondingly, and quantization parameters qt(0)˜qt(N2) of the models md2(0)˜md2(N2) can be evaluated through the calibration. The quantization parameters qt(0)˜qt(N2) may reflect value ranges (i.e., ranges of floating point values) for weights at nodes and layers in the models md2(0)˜md2(N2). Taking three models md2(0), md2(1) and md2(2) as examples and referring to FIG. 5 which illustrates the quantization parameters qt(0), qt(1) and qt(2) thereof. The calibration data ca(0) is fed into the model md2(0) to evaluate the quantization parameter qt(0) of the model md2(0). The quantization parameter qt(0) reflects a value range of (−48, 50), which has a minimum value of “−48” and a maximum value of “50”. Furthermore, another calibration data ca(1) is fed into the corresponding model md2(1) to evaluate the quantization parameter qt(1) of the model md2(1), which reflects a value range of (−46, 55) with a minimum value of “−46” and a maximum value of “55”. Likewise, still another calibration data ca(2) is fed into the model md2(2) correspondingly, so as to evaluate its quantization parameter qt(2), which reflects a value range of (−44, 54) with a minimum value of “−44” and a maximum value of “54”.

Now, please refer back to FIGS. 3 and 4, next, the pre-calibration process proceeds to step S304: obtaining the unified quantization parameter based on the plurality of quantization parameters. For example, a unified quantization parameter u_qt is obtained based on the quantization parameters qt(0)˜qt(N2) of the models md2(0)˜md2(N2). Such a unified quantization parameter u_qt may be referred to as a “unified post-training-quantization (PTQ)”. In one example, the unified quantization parameter u_qt is an union of all the value ranges reflected by the quantization parameters qt(0)˜qt(N2). That is, a global minimum value of all the value ranges reflected by the quantization parameters qt(0)˜qt(N2) is defined as a lower boundary of the unified quantization parameter u_qt. On the other hand, a global maximum value of all the value ranges reflected by the quantization parameters qt(0)˜qt(N2) is defined as an upper boundary of the unified quantization parameter u_qt. In another example, after obtaining the quantization parameters qt(0)˜qt(N2), obtaining more value ranges (may called as “weighted ranges”) by performing weighted operation on these quantization parameters qt(0)˜qt(N2), thus the unified quantization parameter u_qt is obtained not only by the value ranges of the quantization parameters qt(0)˜qt(N2), but also by the weighted ranges.

Please refer to FIG. 5 again, it also shows the value range reflected by the unified quantization parameter u_qt. All the minimum values of value ranges reflected by quantization parameters qt(0)˜qt(N2) of all models md2(0)˜md2(N2) are considered to determine the lower boundary of the unified quantization parameter u_qt. Such as, the quantization parameter qt(8) for model md2(8) achieves the global minimum value of “−50”, hence the lower boundary of unified quantization parameter u_qt is determined as “−50”. Likewise, all the maximum values of value ranges reflected by quantization parameters qt(0)˜qt(N2) are considered to determine the upper boundary of the unified quantization parameter u_qt. For example, the quantization parameter qt(12) for model md2(12) achieves the global maximum value of “56”, hence the upper boundary of unified quantization parameter u_qt is determined as “56”.

From step S300 to step S304, the models md2(0)˜md2(N2) (i.e., the second set of models) are obtained in step S300, calibrated in step S302, then the unified quantization parameter u_qt is obtained in step S304. In the examples of FIGS. 1˜5, the models md1(1)˜md1(N1) (i.e., the first set of models) are quantized, compiled and then deployed/inferenced. On the other hand, the models md2(0)˜md2(N2) (i.e., the second set of models) are utilized only for obtaining unified quantization parameter u_qt, which are not quantized, compiled and deployed.

Alternatively, besides being utilized for obtaining unified quantization parameter u_qt, the models md2(0)˜md2(N2) may also be quantized, compiled and deployed/inferenced. In still another example, only one model is selected from the models md2(0)˜md2(N2), and quantization, compilation and deployment are only performed on this selected model.

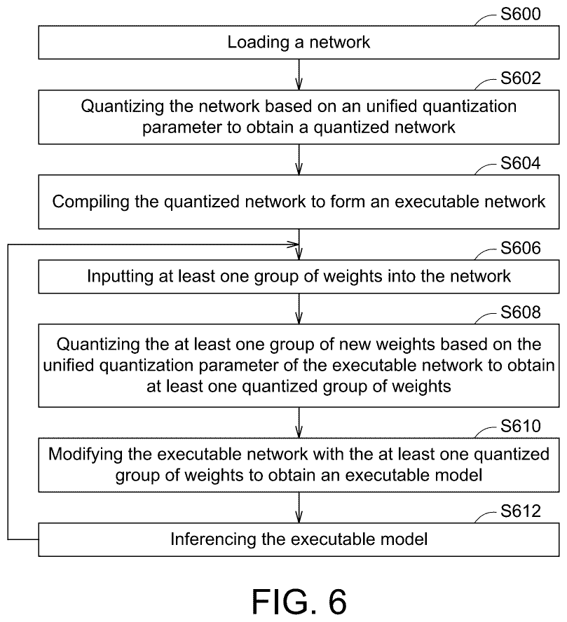

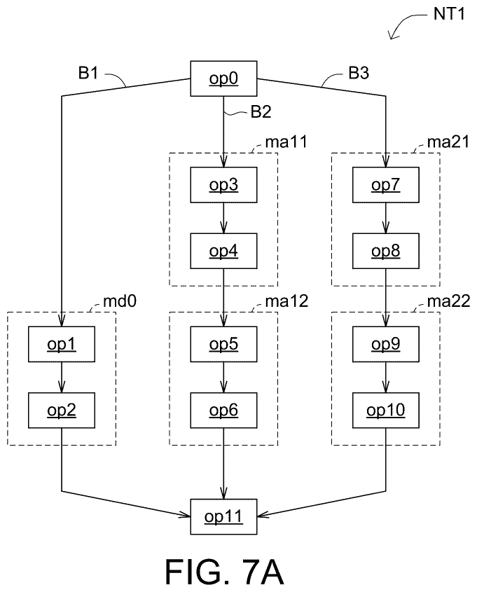

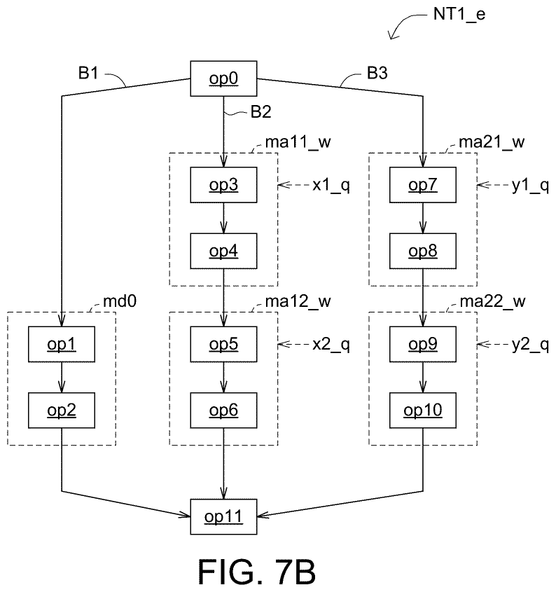

FIG. 6 is a flow diagram of a data processing method according to another embodiment of the present disclosure. Referring to FIG. 6, the data processing method begins at step S600: loading a network, such as NT1. Also referring to FIG. 7A, which shows an exemplary structure of the network NT1. The network NT1 has several branches, e.g., three branches B1, B2 and B3. The branch B1 is associated with operation units op1 and op2, the branch B2 is associated with operation units op3˜op6, and the branch B3 is associated with operation units op7˜op10. Furthermore, the three branches B1, B2 and B3 are superposed by the operation unit op11, where the operation unit op11 may perform a function of an adder to execute this superposing.

Like the operation unit op11, each of the operation units op1˜op10 may perform a respective operation, for example, 2D convolution (i.e., “2D conv”), 3D convolution (i.e., “3D conv”), or “reshaping”, etc. The branch B1 with the operation units op1 and op2 form a base model md0. Furthermore, the branch B2 with the operation units op3 and op4 form a model adaptation (MA) ma11, while the branch B2 with the operation units op5 and op6 form a model adaptation ma12. Likewise, the branch B3 with the operation units op7 and op8 form a model adaptation ma21, while the branch B2 with the operation units op9 and op10 form a model adaptation ma22. As mentioned in the examples of FIGS. 3˜5, the model adaptations ma11˜ma22 of FIG. 7A may be small neural network modules to perform predefined tasks or predefined domains, e.g., the LoRA associated with various styles and/or characters of interested image(s). The model adaptations ma11˜ma22 can be inserted into the network NT1 to cooperate with the base model md0, such that the network NT1 can be adapted to perform predefined tasks or predefined domains. It should be noted that, the network NT1 in FIG. 7A can receive weights as input. Besides, the number of branches or operation units shown in FIG. 7A are just for illustrating purpose, in other embodiments, the number of the branches or the operations could be other values, for example, besides the branch of base model, the network of this disclosure can comprise at least one other branch, each of the other branch represents a model adaptation. In some embodiments, the weights of the base model are usually loaded along with the network, but the weights of the MA, e.g., the weights of the second branch B2 and the third branch B3, are not loaded along with the network and can be input after loading the network.

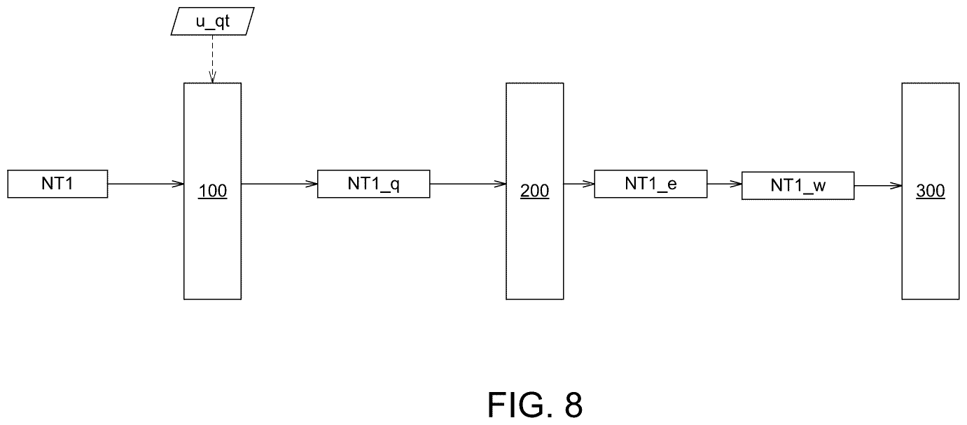

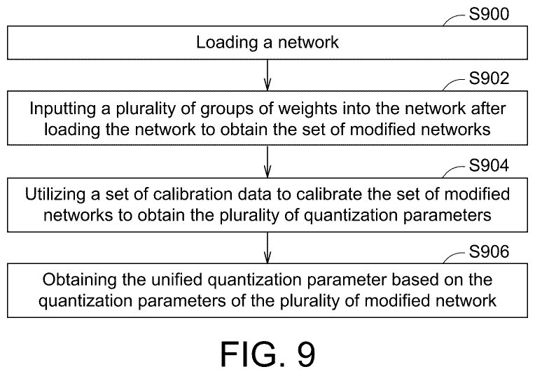

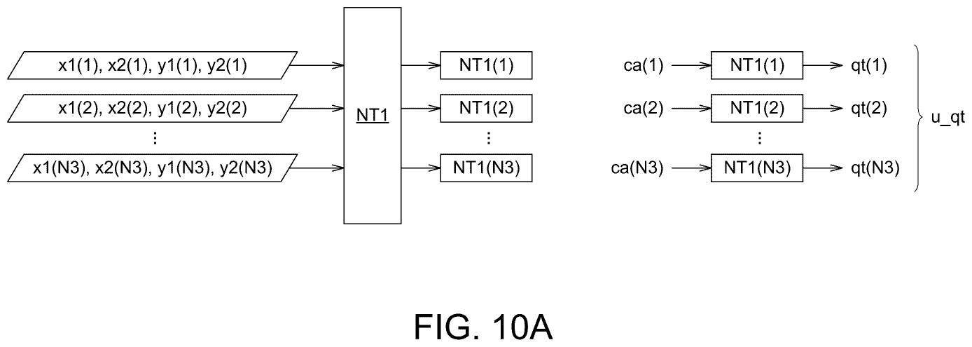

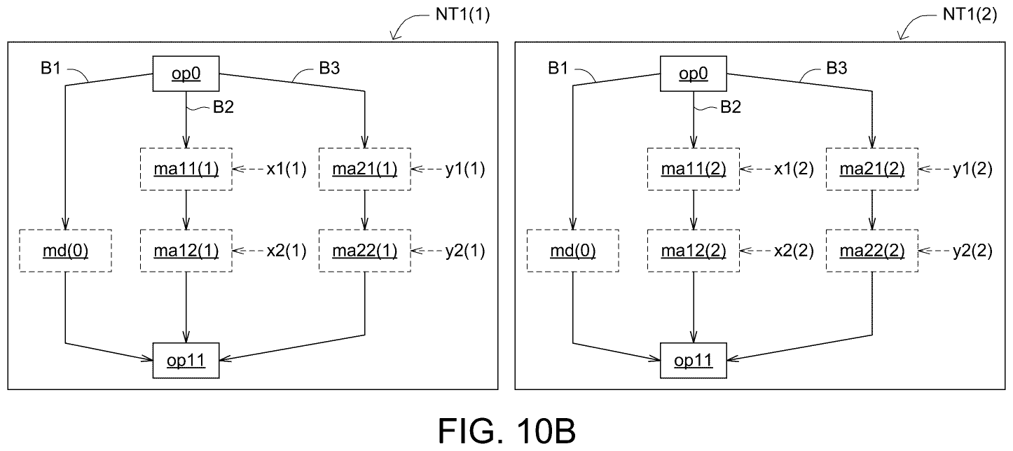

Next, the data processing method proceeds to step S602: quantizing the network based on a unified quantization parameter to obtain a quantized network. For example, in step S602, quantizing the network NT1 based on a unified quantization parameter u_qt, so as to obtain a quantized network NT1_q. Also referring to FIG. 8, which shows a schematic diagram of the data processing method of FIG. 6. A quantization unit 100 (which may be a hardware circuit or a software module) like the quantization unit 100 of FIG. 2 may be configured to perform the quantization. In one example, the network NT1 originally has floating-point values with 32 points (i.e., “FP32”), and such a network NT1 may be quantized into the quantized network NT1_q with fixed-point values or integer values (e.g., integer values with 16 points (“INT16”)). Similar to the unified quantization parameter u_qt in steps S302 and S304 as the embodiment of FIGS. 3 and 4, the unified quantization parameter u_qt for quantizing the network NT1 is predetermined, and may be obtained according to a pre-calibration process. In the pre-calibration process, the network NT1 is modified by several groups of weights to obtain a plurality of modified network NT1(1), NT1(2), . . . , NT1(N3), and the modified network NT1(1), NT1(2), . . . , NT1(N3), are used to obtain the unified quantization parameter u_qt, as will be discussed later by reference to FIGS. 9 and 10.

Next, the data processing method proceeds to step S604: executing a compilation process. In the compilation process, compiling the quantized network to form an executable network. For example, in step S604, compiling the quantized network NT1_q as an executable network NT1_e, by a hardware/software based compilation unit 200 (like the compilation unit in FIG. 2).

Next, the data processing method proceeds to step S606: inputting at least one group of weights into the executable network, such as NT1_e. For example, in step S606, inputting four groups of weights x1, x2, y1 and y2 into the executable network NT1_e, where the first group of weights x1 are provided for the model adaptation ma11, furthermore, the second group of weights x2 are provided for the model adaptation ma12. Likewise, the third group of weights y1 are provided for the model adaptation ma21, while the fourth group of weights y2 are provided for the model adaptation ma22.

Next, the data processing method proceeds to step S608: quantizing the at least one group of weights based on the unified quantization parameter of the executable network to obtain at least one quantized group of weights. For example, in step S608, quantizing the groups of weights x1, x2, y1 and y2 based on the unified quantization parameter u_qt. In one example, each of the groups of weights x1, x2, y1 and y2 may be respectively quantized with the quantization parameter u_qt, so as to form quantized groups of weights x1_q, x2_q, y1_q and y2_q. In another example, the groups of weights x1, x2, y1 and y2 may be firstly combined as a total weight set wm, and such a combined weight set wm is then quantized with the quantization parameter u_qt, forming a quantized combined weight set wm_q.

Next, the data processing method proceeds to step S610: modifying the executable network with the at least one quantized group of weights to obtain an executable model. For example, in step S610, modifying the executable network NT1_e with the quantized groups of weights x1_q, x2_q, y1_q and y2_q(or alternatively, modifying the executable network NT1_e with the quantized combined weight set wm_q). Specifically, the model adaptations ma11, ma12, ma21 and ma22 are weighted by each group of the groups of quantized weights x1_q, x2_q, y1_q and y2_q, forming weighted model adaptations ma11_w, ma12_w, ma21_w and ma22_w, as shown in FIG. 7B (which is a schematic diagram showing the weighted model adaptations). The weighted model adaptation ma11_w is represented as (ma11*x1_q). Likewise, the other weighted model adaptations ma12_w, ma21_w and ma22_w are represented as (ma12*x2_q), (ma21*y1_q) and (ma22*y2_q) correspondingly. Then, the operation unit op11 may perform an operation to superpose the base model md0 with the weighted model adaptations ma11_w, ma12_w, ma21_w and ma22_w, forming an executable model NT1_w.

Next, the data processing method proceeds to step S612: inferencing the executable model. For example, in step S612, executing an inference process to deploy the executable model NT1_w on an execution module 300. Thus, the executable model NT1_w can achieve variety of model adaptations based on the weighted model adaptations ma11_w, ma12_w, ma21_w and ma22_w.

In some alternative embodiments, after step S612, the data processing method can move back to step S606 to provide new groups of weights as input. Thus, the data processing method will go through steps S606-S612 repeatedly. During each repetition, in step S610, the executable model NT1_w can achieve new model adaptations based on the weighted model adaptations ma11_w, ma12_w, ma21_w and ma22_w according to the new groups of weights. That is, in this disclosure, the MAs of the executable model may be adjusted in a real-time manner.

In some alternative embodiments, after obtaining the executable model in step S610, step S612 can be executed repeatedly according to different application requirements.

As discussed in former paragraphs, the unified quantization parameter u_qt in step S602 of the embodiment of FIG. 6 is predetermined and obtained according to a pre-calibration process. Now, referring to FIG. 9, which is a flow diagram of a pre-calibration process for obtaining the unified quantization parameter u_qt of FIG. 6, also referring to FIG. 10A, which is a schematic diagram showing the pre-calibration process of FIG. 9. The pre-calibration process begins at step S900: loading a network which comprises a plurality of operation units. The step S900 is the same as step S600. Next, the pre-calibration process proceeds to step S902, inputting a plurality of groups of weights into the network after loading the network to obtain the set of modified networks. In some embodiment, each of the plurality of groups of weights are input into the network respectively, and a corresponding modified network could be obtained according to each the plurality of groups of weights. In other embodiments, some combinations of the plurality of groups of weights (such as, the weighted sum of the plurality of groups of weights) are input into the network respectively, and a corresponding modified network could be obtained according to each of the combination. In the example of FIG. 10A, a first combination of the weight groups x1(1), x2(1), y1(1) and y2(1) may be input into the network NT1 to obtain a modified network NT1(1), and a second combination of the weight groups x1(2), x2(2), y1(2) and y2(2) may be input into the network NT1 to obtain a modified network NT1(2), and a third combination of the weight groups x1(N3), x2(N3), y1(N3) and y2(N3) may be input into the network NT1 to obtain a modified network NT1(N3). Besides, as mentioned before, the network NT1 may comprise a base model and at least one model adaption (MA). In this situation, each group of weights of the plurality of groups of weights associate with a MA or a combination of the plurality of groups of weights associate with a MA. For example, in some embodiments, each of the weight groups x1(1), x2(1), y1(1) and y2(1), x1(2), x2(2), y1(2) and y2(2), etc. may associate with a MA. In some other embodiments, a combination of weight groups x1(1), x2(1), y1(1) and y2(1) may associate with a MA_A, and combination of weight groups x1(2), x2(2), y1(2) and y2(2) may associate with a MA_B. In some embodiments, each of the MA_A and MA_B is equivalent to a plurality of MAs.

Referring to FIG. 10B, which is a schematic diagram showing modified networks NT1(1) and NT1(2) formed based on weight groups. Weight groups x1(1), x2(1), y1(1) and y2(1) are provided to the model adaptations ma11, ma12, ma21 and ma22 respectively, so as to form weighted model adaptations ma11(1), ma12(1), ma21(1) and ma22(1). Then, these weighted model adaptations ma11(1), ma12(1), ma21(1) and ma22(1) are superposed with the base model md(0) to form a modified network NT1(1). Such a modified network NT1(1) can serve as a completed model.

Similarly, weight groups x1(2), x2(2), y1(2) and y2(2) are also provided to the model adaptations ma11, ma12, ma21 and ma22 respectively to form weighted model adaptations ma11(2), ma12(2), ma21(2) and ma22(2), which are superposed with the base model md(0) to form a modified network NT1(2). Such a modified network NT1(2) can serve as a completed model.

Similarly, weight groups x1(N3), x2(N3), y1(N3) and y2(N3) are also provided to the model adaptations ma11, ma12, ma21 and ma22 respectively to form weighted model adaptations ma11(N3), ma12(N3), ma21(N3) and ma22(N3), which are superposed with the base model md(0) to form a modified network NT1(N3). Such a modified network NT1(N3) can serve as a completed model.

Next, the pre-calibration process proceeds to step S904, utilizing a set of calibration data to calibrate the set of modified networks to obtain the plurality of quantization parameters. For example, in FIG. 10A, utilizing a set of calibration data ca(1), ca(2), . . . , and ca(N3) to calibrate the modified networks NT1(1), NT1(2), . . . , and NT1(N3) respectively, to obtain a plurality of quantization parameters qt(1), qt(2), . . . , and qt(N3). Wherein the quantization parameter qt(1) represents the value ranges (i.e., ranges of floating point values) for weights at nodes and layers in the modified network NT1(1). Wherein the quantization parameter qt(2) represents the value ranges (i.e., ranges of floating point values) for weights at nodes and layers in the modified network NT1(2). Wherein the quantization parameter qt(N3) represents the value ranges (i.e., ranges of floating point values) for weights at nodes and layers in the modified network NT1(N3).

Next, executing step S906: obtaining the unified quantization parameter based on the quantization parameters of the plurality of modified network. For example, in step S906, obtaining the unified quantization parameter u_qt based on the quantization parameters qt(1), qt(2), . . . , and qt(N3). For example, the unified quantization parameter u_qt is formed to have a value range covering all values in each of the quantization parameters qt(1), qt(2), . . . , and qt(N3). For example, a global minimum value of all the value ranges reflected by the plurality of quantization parameters qt(1), qt(2), . . . , and qt(N3) is defined as a lower boundary of the unified quantization parameter, and a global maximum value of all the value ranges reflected by the plurality of quantization parameters qt(1), qt(2), . . . , and qt(N3) is defined as an upper boundary of the unified quantization parameter. The above resulted, unified quantization parameter u_qt, is employed to quantize the network NT1 in step S602 of FIG. 6. In some embodiments, after obtaining the quantization parameters qt(1), qt(2), . . . , and qt(N3), further obtaining more value ranges (may called as “weighted ranges”) by performing weighted operation on these quantization parameters qt(1), qt(2), . . . , and qt(N3), thus the unified quantization parameter u_qt is obtained not only by the value ranges of the quantization parameters qt(1), qt(2), . . . , and qt(N3), but also by the weighted ranges.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A data processing method, comprising:
loading a first set of models; and
quantizing the first set of models based on a unified quantization parameter to obtain a first set of quantized models;
wherein the first set of models comprise at least one model, the first set of quantized models comprise at least one quantized model, and the unified quantization parameter is obtained according to a plurality of quantization parameters of a second set of models.

2. The data processing method of claim 1, further comprising:
compiling the first set of quantized models to form a first set of executable models, wherein the first set of executable models comprise at least one executable model.

3. The data processing method of claim 2, further comprising:
inferencing the first set of executable models.

4. The data processing method of claim 1, wherein the unified quantization parameter is obtained in a pre-calibration process, and the pre-calibration process comprises:
obtaining the second set of models which comprises a plurality of models;
utilizing a set of calibration data to calibrate the second set of models to obtain the plurality of quantization parameters; and
obtaining the unified quantization parameter based on the plurality of quantization parameters.

5. The data processing method of claim 4, wherein a global minimum value of all the value ranges reflected by the plurality of quantization parameters is defined as a lower boundary of the unified quantization parameter, and a global maximum value of all the value ranges reflected by the plurality of quantization parameters is defined as an upper boundary of the unified quantization parameter.

6. The data processing method of claim 5, wherein all the value ranges reflected by the plurality of quantization parameters comprise at least one value range obtained by performing weighted operation on the plurality of quantization parameters.

7. The data processing method of claim 4, wherein the first set of models comprise at least one adapted model, and the second set of models comprise a base model and a plurality of adapted models, each adapted model is obtained by performing model adaptation (MA) to the base model.

8. The data processing method of claim 7, wherein each model of the first set of models and the second set of models is a stable diffusion model for performing a text-to-image generation for a plurality of images, or each model of the first set of models and the second set of models is a large language model (LLM) for performing natural language processing tasks.

9. The data processing method of claim 7, wherein the model adaptation comprises at least one low-rank adaptation (LoRA) for various styles or various characters of the images.

10. A data processing method, comprising:
loading a network which comprises a plurality of operation units; and
quantizing the network based on a unified quantization parameter to obtain a quantized network;
wherein the unified quantization parameter is obtained according to a plurality of quantization parameters of a set of modified networks, wherein the set of modified networks are obtained by inputting a plurality of groups of weights into the network.

11. The data processing method of claim 10, wherein the network comprises a base model and at least one model adaption (MA), the base model and each of the MA comprise at least one operation unit of the plurality of operation units.

12. The data processing method of claim 11, wherein each group of weights of the plurality of groups of weights associate with a MA or a combination of the plurality of groups of weights associate with a MA.

13. The data processing method of claim 10, wherein the unified quantization parameter is obtained in a pre-calibration process, and the pre-calibration process comprises:
inputting a plurality of groups of weights into the network after loading the network to obtain the set of modified networks;
utilizing a set of calibration data to calibrate the set of modified networks to obtain the plurality of quantization parameters; and
obtaining the unified quantization parameter based on the quantization parameters of the plurality of modified network.

14. The data processing method of claim 13, wherein a global minimum value of all the value ranges reflected by the plurality of quantization parameters is defined as a lower boundary of the unified quantization parameter, and a global maximum value of all the value ranges reflected by the plurality of quantization parameters is defined as an upper boundary of the unified quantization parameter.

15. The data processing method of claim 14, wherein all the value ranges reflected by the plurality of quantization parameters comprise at least one value range obtained by performing weighted operation on the plurality of quantization parameters.

16. The data processing method of claim 14, wherein each modified network of the set of modified networks is obtained by inputting a group of weights into the network, or each modified network of the set of modified networks is obtained by inputting a combination of some groups of weights of the plurality of groups of weights into the network.

17. The data processing method of claim 10, further comprising:
compiling the quantized network to form an executable network.

18. The data processing method of claim 17, further comprising:
inputting at least one group of new weights into the executable network;
quantizing the at least one group of new weights based on the unified quantization parameter of the executable network to obtain at least one quantized group of new weights;
modifying the executable network with the at least one quantized group of new weights to obtain an executable model; and
inferencing the executable model.

19. The data processing method of claim 18, further comprising:
moving back to the inputting step after the inferencing step.

20. The data processing method of claim 18, wherein the executable network comprises a base model and at least one model adaption (MA), the base model and each of the MA comprises at least one operation unit of the plurality of operation units;
wherein each group of new weights of the at least one group of new weights associate with a MA of the at least one MA.
